(19) United States
(12) Patent Application Publication
(10) Pub. No.: US 2010/0048081 A1
(43) Pub. Date: Feb. 25, 2010

(54) BIODEGRADABLE POLYESTERS FOR USE IN FORMING FIBERS

(76) Inventors: Vasily A. Topolkaraev, Appleton, WI (US); Gregory J. Wideman, Menasha, WI (US); Ross T. Kaufman, Neenah, WI (US); Alan E. Wright, Woodstock, GA (US); Jeffrey J. Krueger, Roswell, GA (US); Jayant Chakravarty, Woodbury, MN (US)

Correspondence Address: DORITY & MANNING, P.A., POST OFFICE BOX 1449, GREENVILLE, SC, 29602-1449, US

(21) Appl. No.: 12/513,557

(22) PCT Filed: Dec. 15, 2006
(86) PCT No.: PCT/US06/47852

§ 371 Date: Jun. 29, 2009

(51) Int. Cl. D04H 1/00; C08G 63/00

(52) U.S. Cl. 442/400; 526/318.25

(57) ABSTRACT

A method for forming a biodegradable polyester suitable for use in fibers is provided. Specifically, a biodegradable polyester is melt processed at a controlled water content to initiate a hydrolysis reaction. Without intending to be limited by theory, it is believed that the hydroxyl groups present in water are capable of attacking the ester linkage of the polyester, thereby leading to chain scission or “depolymerization” of the polyester molecule into one or more shorter ester chains. By selectively controlling the reaction conditions (e.g., water content, temperature, shear rate, etc.), a hydrolytically degraded polyester may be achieved that has a molecular weight lower than the starting polymer. Such lower molecular weight polymers have a higher melt flow rate and lower apparent viscosity, which are useful in a wide variety of fiber forming applications, such as in the meltblowing of nonwoven webs.

### BACKGROUND OF THE INVENTION

Biodegradable nonwoven webs are useful in a wide range of applications, such as in the formation of disposable absorbent products (e.g., diapers, training pants, sanitary wipes, feminine pads and liners, adult incontinence pads, guards, garments, etc.). To facilitate formation of the nonwoven web, a biodegradable polymer should be selected that is melt processable, yet also has good mechanical and physical properties. Although various attempts have been made to use biodegradable polyesters in the formation of nonwoven webs, their relatively high molecular weight and viscosity have generally restricted their use to only certain types of film forming processes, but not fiber forming processes. For example, conventional aliphatic polyesters are not typically suitable for meltblowing processes, which require a low polymer viscosity for successful microfiber formation. As such, a need currently exists for a biodegradable polyester that exhibits good mechanical and physical properties, but which may be readily formed into a nonwoven web using a variety of techniques (e.g., meltblowing).

### SUMMARY OF THE INVENTION

In accordance with one embodiment of the present invention, a method for forming a biodegredable polymer for use in fiber formation is disclosed. The method comprises melt processing a first polyester at a water content of from about 500 to about 5000 parts per million (“ppm”), based on the dry weight of the first polyester. The polyester undergoes a hydrolysis reaction that results in a second, hydrolytically degraded polyester having a melt flow rate that is greater than the melt flow rate of the first biodegradable polyester, determined on a dry basis at a load of 2160 grams and temperature of 190° C. in accordance with ASTM Test Method D1238-E.

In accordance with another embodiment of the present invention, a fiber is disclosed that comprises a biodegradable, hydrolytically degraded polyester. The polyester has a melt flow rate of from about 10 to about 1000 grams per 10 minutes, determined on a dry basis at a load of 2160 grams and temperature of 190° C. in accordance with ASTM Test Method D1238-E.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration of a process that may be used in one embodiment of the present invention to form a nonwoven web;

FIG. 2 is a schematic illustration of a process that may be used in one embodiment of the present invention to form a coform web; and

FIG. 3 is a perspective view of one embodiment of an absorbent article that may be formed according to the present invention.

Repeat use of references characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

### DEFINITIONS

As used herein, the term “biodegradable” or “biodegradable polymer” generally refers to a material that degrades from the action of naturally occurring microorganisms, such as bacteria, fungi, and algae; environmental heat; moisture; or other environmental factors. The biodegradability of a material may be determined using ASTM Test Method 5338.92.

As used herein, the term “fibers” refer to elongated extrudates formed by passing a polymer through a forming orifice such as a die. Unless noted otherwise, the term “fibers” includes discontinuous fibers having a definite length and substantially continuous filaments. Substantially filaments may, for instance, have a length much greater than their diameter, such as a length to diameter ratio (“aspect ratio”) greater than about 15,000 to 1, and in some cases, greater than about 50,000 to 1.

As used herein, the term “monocomponent” refers to fibers formed from one polymer. Of course, this does not exclude fibers to which additives have been added for color, anti-static properties, lubrication, hydrophilicity, liquid repellency, etc.

As used herein, the term “multicomponent” refers to fibers formed from at least two polymers (e.g., bicomponent fibers) that are extruded from separate extruders. The polymers are arranged in substantially constantly positioned distinct zones across the cross-section of the fibers. The components may be arranged in any desired configuration, such as sheath-core, side-by-side, segmented pie, island-in-the-sea, and so forth. Various methods for forming multicomponent fibers are described in U.S. Pat. Nos. 4,789,592 to Taniguchi et al. and 5,336,552 to Strack et al., 5,108,820 to Kaneko, et al., 4,795,668 to Kruege, et al., 5,382,400 to Pike, et al., 5,336,552 to Strack, et al., and 6,200,669 to Marmon, et al., which are incorporated herein in their entirety by reference thereto for all purposes. Multicomponent fibers having various irregular shapes may also be formed, such as described in U.S. Pat. Nos. 5,277,976 to Hogle, et al., 5,162,074 to Hills, 5,466,410 to Hills, 5,069,970 to Largman, et al., and 5,057,368 to Largman. et al., which are incorporated herein in their entirety by reference thereto for all purposes.

As used herein, the term “multiconstituent” refers to fibers formed from at least two polymers (e.g., biconstituent fibers) that are extruded as a blend. The polymers are not arranged in substantially constantly positioned distinct zones across the cross-section of the fibers. Various multiconstituent fibers are described in U.S. Pat. No. 5,108,827 to Gessner, which is incorporated herein in its entirety by reference thereto for all purposes.

As used herein, the term “nonwoven web” refers to a web having a structure of individual fibers that are randomly interlaid, not in an identifiable manner as in a knitted fabric. Nonwoven webs include, for example, meltblown webs, spunbond webs, carded webs, wet-laid webs, airlaid webs, coform webs, hydraulically entangled webs, etc. The basis weight of the nonwoven web may generally vary, but is typically from about 5 grams per square meter (“gsm”) to 200 gsm, in some embodiments from about 10 gsm to about 150 gsm, and in some embodiments, from about 15 gsm to about 100 gsm.

As used herein, the term “meltblown” web or layer generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. Nos. 3,849,241 to Butin, et al.; 4,307,143 to Meitner. et al.; and 4,707,398 to Wisneski, et al., which are incorporated herein in their entirety by reference thereto for all purposes. Meltblown fibers may be substantially continuous or discontinuous, and are generally tacky when deposited onto a collecting surface.

As used herein, the term “spunbond” web or layer generally refers to a nonwoven web containing small diameter substantially continuous filaments. The filaments are formed by extruding a molten thermoplastic material from a plurality of fine, usually circular, capillaries of a spinnerette with the diameter of the extruded filaments then being rapidly reduced as by, for example, eductive drawing and/or other well-known spunbonding mechanisms. The production of spunbond webs is described and illustrated, for example, in U.S. Pat. Nos. 4,340,563 to Appel, et al., 3,692,618 to Dorschner, et al., 3,802,817 to Matsuki, et al., 3,338,992 to Kinney, 3,341,394 to Kinney, 3,502,763 to Hartman, 3,502,538 to Levy, 3,542,615 to Dobo, et al., and 5,382,400 to Pike, et al., which are incorporated herein in their entirety by reference thereto for all purposes. Spunbond filaments are generally not tacky when they are deposited onto a collecting surface. Spunbond filaments may sometimes have diameters less than about 40 micrometers, and are often between about 5 to about 20 micrometers.

As used herein, the term “carded web” refers to a web made from staple fibers that are sent through a combing or carding unit, which separates or breaks apart and aligns the staple fibers in the machine direction to form a generally machine direction-oriented fibrous nonwoven web. Such fibers are usually obtained in bales and placed in an opener/blender or picker, which separates the fibers prior to the carding unit. Once formed, the web may then be bonded by one or more known methods.

As used herein, the term “airlaid web” refers to a web made from bundles of fibers having typical lengths ranging from about 3 to about 19 millimeters (mm). The fibers are separated, entrained in an air supply, and then deposited onto a forming surface, usually with the assistance of a vacuum supply. Once formed, the web is then bonded by one or more known methods.

As used herein, the term “coform web” generally refers to a composite material containing a mixture or stabilized matrix of thermoplastic fibers and a second non-thermoplastic material. As an example, coform materials may be made by a process in which at least one meltblown die head is arranged near a chute through which other materials are added to the web while it is forming. Such other materials may include, but are not limited to, fibrous organic materials such as woody or non-woody pulp such as cotton, rayon, recycled paper, pulp fluff and also superabsorbent particles, inorganic and/or organic absorbent materials, treated polymeric staple fibers and so forth. Some examples of such coform materials are disclosed in U.S. Pat. Nos. 4,100,324 to Anderson, et al.; 5,284,703 to Everhart. et al.; and 5,350,624 to Georger, et al.; which are incorporated herein in their entirety by reference thereto for all purposes.

### DETAILED DESCRIPTION

The present invention is directed to a method for forming a biodegradable polyester suitable for use in fibers. Specifically, a biodegradable polyester is melt processed at a controlled water content to initiate a hydrolysis reaction. Without intending to be limited by theory, it is believed that the hydroxyl groups present in water are capable of attacking the ester linkage of the polyester, thereby leading to chain scission or “depolymerization” of the polyester molecule into one or more shorter ester chains. By selectively controlling the reaction conditions (e.g., water content, temperature, shear rate, etc.), a hydrolytically degraded polyester may be achieved that has a molecular weight lower than the starting polymer. Such lower molecular weight polymers have a higher melt flow rate and lower apparent viscosity, which are useful in a wide variety of fiber forming applications, such as in the meltblowing of nonwoven webs.

### I. Reaction Components

A. Biodegradable Polyester

Any of a variety of biodegradable polyesters may be employed in the present invention, including, for instance, aliphatic polyesters, polyhydroxyalkanoates (PHA), polyhydroxybutyrates (PHB), polyhydroxyvalerates (PHV), polyhydroxybutyrate-hydroxyvalerate copolymers (PHBV), polyhydroxyvalerate, polyhydroxybutyrate-hydroxyvalerate copolymer and polycaprolactone), aromatic polyesters, aliphatic-aromatic copolyesters, and so forth. Of course, the polyester may also be blended with other types of polymers (e.g., polyolefins, polylactic acid, etc.) to provided a variety of different of benefits, such as processing, fiber formation, etc.

Aliphatic polyesters, for instance, may be synthesized from the polymerization of a polyol with an aliphatic carboxylic acid or anhydride thereof. Generally speaking, the carboxylic acid monomer constituents of such polyesters are predominantly aliphatic in nature in that they lack aromatic rings. For example, at least about 80 mol. %, in some embodiments at least about 90 mol. %, and in some embodiments, at least about 95 mol. % of the carboxylic acid monomer constituents may be aliphatic monomers. In one particular embodiment, the carboxylic acid monomer constituents are formed from aliphatic dicarboxylic acids (or anhydrides thereof). Representative aliphatic dicarboxylic acids that may be used to form the aliphatic polyester may include substituted or unsubstituted, linear or branched, non-aromatic dicarboxylic acids selected from aliphatic dicarboxylic acids containing 2 to about 12 carbon atoms, and derivatives thereof. Non-limiting examples of aliphatic dicarboxylic acids include malonic, succinic, oxalic, glutaric, adipic, pimelic, azelaic, sebacic, fumaric, 2,2-dimethyl glutaric, suberic, 1,3-cyclopentanedicarboxylic, 1,4-cyclohexanedicarboxylic, 1,3-cyclohexanedicarboxylic, diglycolic, itaconic, maleic, and 2,5-norbornanedicarboxylic.

Suitable polyols used to form the aliphatic polyester may be substituted or unsubstituted, linear or branched, polyols selected from polyols containing 2 to about 12 carbon atoms and polyalkylene ether glycols containing 2 to 8 carbon atoms. Examples of polyols that may be used include, but are not limited to, ethylene glycol, diethylene glycol, propylene glycol, 1,2-propanediol, 1,3-propanediol, 2,2-dimethyl-1,3-propanediol, 1,2-butanediol, 1,3-butanediol, 1,4-butanediol, 1,2-pentanediol, 1,5-pentanediol, 1,6-hexanediol, polyethylene glycol, diethylene glycol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutanediol, cyclopentanediol, triethylene glycol, and tetraethylene glycol. Preferred polyols include 1,4-butanediol; 1,3-propanediol; ethylene glycol; 1,6-hexanediol; diethylene glycol; and 1,4-cyclohexanedimethanol.

The polymerization may be catalyzed by a catalyst, such as a titanium-based catalyst (e.g., tetraisopropyltitanate, tetraisopropoxy titanium, dibutoxydiacetoacetoxy titanium, or tetrabutyltitanate). If desired, a diisocyanate chain extender may be reacted with the polyester to increase its molecular weight. Representative diisocyanates may include toluene 2,4-diisocyanate, toluene 2,6-diisocyanate, 2,4′-diphenylmethane diisocyanate, naphthylene-1,5-diisocyanate, xylylene diisocyanate, hexamethylene diisocyanate (“HMDI”), isophorone diisocyanate and methylenebis(2-isocyanatocyclohexane). Trifunctional isocyanate compounds may also be employed that contain isocyanurate and/or biurea groups with a functionality of not less than three, or to replace the diisocyanate compounds partially by tri- or polyisocyanates. The preferred diisocyanate is hexamethylene diisocyanate. The amount of the chain extender employed is typically from about 0.3 to about 3.5 wt. %, in some embodiments, from about 0.5 to about 2.5 wt. % based on the total weight percent of the polymer.

The polyester may either be a linear polymer or a long-chain branched polymer. Long-chain branched polymers are generally prepared by using a low molecular weight branching agent, such as a polyol, polycarboxylic acid, hydroxy acid, and so forth. Representative low molecular weight polyols that may be employed as branching agents include glycerol, trimethylolpropane, trimethylolethane, polyethertriols, glycerol, 1,2,4-butanetriol, pentaerythritol, 1,2,6-hexanetriol, sorbitol, 1,1,4,4,-tetrakis (hydroxymethyl)cyclohexane, tris(2-hydroxyethyl) isocyanurate, and dipentaerythritol. Representative higher molecular weight polyols (molecular weight of 400 to 3000) that may be used as branching agents include triols derived by condensing alkylene oxides having 2 to 3 carbons, such as ethylene oxide and propylene oxide with polyol initiators. Representative polycarboxylic acids that may be used as branching agents include hemimellitic acid, trimellitic (1,2,4-benzenetricarboxylic) acid and anhydride, trimesic (1,3,5-benzenetricarboxylic) acid, pyromellitic acid and anhydride, benzenetetracarboxylic acid, benzophenone tetracarboxylic acid, 1,1,2,2-ethane-tetracarboxylic acid, 1,1,2-ethanetricarboxylic acid, 1,3,5-pentanetricarboxylic acid, and 1,2,3,4-cyclopentanetetracarboxylic acid. Representative hydroxy acids that may be used as branching agents include malic acid, citric acid, tartaric acid, 3-hydroxyglutaric acid, mucic acid, trihydroxyglutaric acid, 4-carboxyphthalic anhydride, hydroxyisophthalic acid, and 4-(beta-hydroxyethyl)phthalic acid. Such hydroxy acids contain a combination of 3 or more hydroxyl and carboxyl groups. Especially preferred branching agents include trimellitic acid, trimesic acid, pentaerythritol, trimethylol propane and 1,2,4-butanetriol.

In one particular embodiment, the aliphatic polyester has the following general structure:

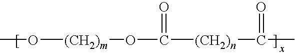

wherein,

m is an integer from 2 to 10, in some embodiments from 3 to 8, and in some embodiments from 2 to 4;

n is an integer from 0 to 18, in some embodiments from 1 to 12, and in some embodiments, from 2 to 4; and

x is an integer greater than 1. Specific examples of such aliphatic polyesters include succinate-based aliphatic polymers, such as polybutylene succinate, polyethylene succinate, polypropylene succinate, and copolymers thereof (e.g., polybutylene succinate adipate); oxalate-based aliphatic polymers, such as polyethylene oxalate, polybutylene oxalate, polypropylene oxalate, and copolymers thereof; malonate-based aliphatic polymers, such as polyethylene malonate, polypropylene malonate, polybutylene malonate, and copolymers thereof; adipate-based aliphatic polymers, such as polyethylene adipate, polypropylene adipate, polybutylene adipate, and polyhexylene adipate, and copolymers thereof; etc., as well as blends of any of the foregoing. Polybutylene succinate, which has the following structure, is particularly desirable:

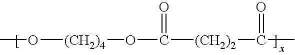

One specific example of a suitable polybutylene succinate polymer is commercially available from IRE Chemicals (South Korea) under the designation ENPOL™ G4500. Other suitable polybutylene succinate resins may include those available under the designation BIONOLLE® from Showa Highpolymer Company (Tokyo, Japan). Still other suitable aliphatic polyesters may be described in U.S. Pat. Nos. 5,714,569; 5,883,199; 6,521,366; and 6,890,989, which are incorporated herein in their entirety by reference thereto for all purposes.

Besides being primarily aliphatic in nature, biodegradable polyesters may also be employed that contain aromatic monomers. In one embodiment, for example, aliphatic-aromatic copolyesters may be employed that are synthesized using any known technique, such as through the condensation polymerization of a polyol in conjunction with aliphatic and aromatic dicarboxylic acids or anhydrides thereof. The polyols and aliphatic dicarboxylic acids may include the representative examples described above. Representative aromatic dicarboxylic acids that may be used include substituted and unsubstituted, linear or branched, aromatic dicarboxylic acids selected from aromatic dicarboxylic acids containing 1 to about 6 carbon atoms, and derivatives thereof. Non-limiting examples of aromatic dicarboxylic acids include terephthalic acid, dimethyl terephthalate, isophthalic acid, dimethyl isophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid), dimethyl-4,4′-methylenebis(benzoate), etc., and mixtures thereof. The aromatic dicarboxylic acid monomer constituent may be present in the copolyester in an amount of from about 10 mole % to about 40 mole %, in some embodiments from about 15 mole % to about 35 mole %, and in some embodiments, from about 15 mole % to about 30 mole %. The aliphatic dicarboxylic acid monomer constituent may likewise be present in the copolyester in an amount of from about 15 mole % to about 45 mole %, in some embodiments from about 20 mole % to about 40 mole %, and in some embodiments, from about 25 mole % to about 35 mole %. The polyol monomer constituent may also be present in the aliphatic-aromatic copolyester in an amount of from about 30 mole % to about 65 mole %, in some embodiments from about 40 mole % to about 50 mole %, and in some embodiments, from about 45 mole % to about 55 mole %.

In one embodiment, the aliphatic-aromatic copolyester may comprise the following structure:

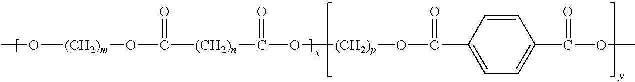

wherein,

m is an integer from 2 to 10, in some embodiments from 2 to 4, and in one embodiment, 4;

n is an integer from 0 to 18, in some embodiments from 2 to 4, and in one embodiment, 4;

p is an integer from 2 to 10, in some embodiments from 2 to 4, and in one embodiment, 4;

x is an integer greater than 1; and

y is an integer greater than 1. One example of such a copolyester is polybutylene adipate terephthalate, which is commercially available under the designation ECOFLEX® F BX 7011 from BASF Corp of Florham Park, N.J. Another example of a suitable copolyester containing an aromatic terephtalic acid monomer constituent is available under the designation ENPOL™ 8060M from IRE Chemicals (South Korea). Other suitable aliphatic-aromatic copolyesters may be described in U.S. Pat. Nos. 5,292,783; 5,446,079; 5,559,171; 5,580,911; 5,599,858; 5,817,721; 5,900,322; and 6,258,924, which are incorporated herein in their entirety by reference thereto for all purposes.

The biodegradable polyesters employed in the present invention typically have a number average molecular weight (“Mₙ”) ranging from about 30,000 to about 160,000 Daltons and a weight average molecular weight (“M_{w}”) ranging from about 30,000 to about 240,000 Daltons. The particular molecular weight depends on the polymer selected. For example, aliphatic polyesters typically have a number average molecular weight (“Mₙ”) ranging from about 60,000 to about 160,000 grams per mole, in some embodiments from about 80,000 to about 140,000 grams per mole, and in some embodiments, from about 100,000 to about 120,000 grams per mole, as well as a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. On the other hand, aliphatic-aromatic copolyesters typically have a number average molecular weight (“Mₙ”) ranging from about 40,000 to about 120,000 grams per mole, in some embodiments from about 50,000 to about 100,000 grams per mole, and in some embodiments, from about 60,000 to about 85,000 grams per mole, as well as a weight average molecular weight (“M_{w}”) ranging from about 70,000 to about 240,000 grams per mole, in some embodiments from about 80,000 to about 190,000 grams per mole, and in some embodiments, from about 100,000 to about 150,000 grams per mole. Regardless, the ratio of the weight average molecular weight to the number average molecular weight (“M_{w}/Mₙ”), i.e., the “polydispersity index”, is normally relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

Although not required, “low melting point” biodegradable polyesters are typically employed in the present invention because they degrade at a fast rate and are soft. For example, suitable “low melting point” biodegradable polyesters may have a melting point of from about 50° C. to about 160° C., in some embodiments from about 80° C. to about 160° C., and in some embodiments, from about 100° C. to about 140° C. The glass transition temperature (“T_{g}”) of the biodegradable polyester is also relatively low to improve flexibility and processability of the polymers. The low melting point biodegradable polyesters may also have a glass transition temperature (“T_{g}”) of about 25° C. or less, in some embodiments about 0° C. or less, and in some embodiments, about −10° C. or less. As discussed in more detail below, the melting temperature and glass transition temperature may all be determined using differential scanning calorimetry (“DSC”) in accordance with ASTM D-3417.

The biodegradable polyesters may also have an apparent viscosity within a certain range. For example, the biodegradable polyesters may have an apparent viscosity of from about 20 to about 215 Pascal seconds (Pa·s), in some embodiments from about 30 to about 200 Pa·s, and in some embodiments, from about 40 to about 150 Pa·s, as determined at a temperature of 160° C. and a shear rate of 1000 sec⁻¹. The melt flow rate of the biodegradable polyesters (dry basis) may also range from about 0.1 to about 10 grams per 10 minutes, in some embodiments from about 0.5 to about 8 grams per 10 minutes, and in some embodiments, from about 1 to about 5 grams per 10 minutes. The melt flow rate is the weight of a polymer (in grams) that may be forced through an extrusion rheometer orifice (0.0825-inch diameter) when subjected to a load of 2160 grams in 10 minutes at a certain temperature (e.g., 190° C.), measured in accordance with ASTM Test Method D1238-E.

B. Water

Under appropriate conditions, water is capable of hydrolytically degrading the starting biodegradable polyester and thus reducing its molecular weight. More specifically, it is believed that the hydroxyl groups of water can attack the ester linkages of the polyester, thereby leading to chain scission or “depolymerization” of the polyester molecule into one or more shorter ester chains. The shorter chains may include polyesters, oligomers, monomers, and combinations of any of the foregoing. The amount of water employed relative to the biodegradable polyester affects the extent to which the hydrolysis reaction is able to proceed. However, if the water content is too great, the natural saturation level of the polymer may be exceeded, which may adversely affect the resin melt properties and the physical properties of the resulting fibers. Thus, in most embodiments of the present invention, the water content is from about 500 to about 5000 parts per million (“ppm”), in some embodiments from about 1000 to about 4500 ppm, in some embodiments from about 2000 to about 3500 ppm, and in some embodiments, from about 2200 to about 3000 ppm, based on the dry weight of the starting biodegradable polyester. The water content may be determined in a variety of ways as is known in the art, such as in accordance with ASTM D 7191-05, such as described in more detail below.

The technique employed to achieve the desired water content is not critical to the present invention. In fact, any of a variety of well known techniques for controlling water content may be employed, such as described in U.S. Patent Application Publication Nos. 2005/0004341 to Culbert, et al. and 2001/0003874 to Gillette, et al., which are incorporated herein in their entirety by reference thereto for all purposes. For example, the water content of the starting polyester may be controlled by selecting certain storage conditions, drying conditions, the conditions of humidification, etc. In one embodiment, for example, the biodegradable polyester may be humidified to the desired water content by contacting pellets of the polymer with an aqueous medium (e.g., liquid or gas) at a specific temperature and for a specific period of time. This enables a targeted water diffusion into the polymer structure (moistening). For example, the polymer may be stored in a package or vessel containing humidified air. Further, the extent of drying of the polymer during manufacture of the polymer may also be controlled so that the starting biodegradable polyester has the desired water content. In still other embodiments, water may be added during melt processing of the polyester as described herein. Thus, the term “water content” is meant to include the combination of any residual moisture (e.g., the amount of water present due to conditioning, drying, storage, etc.) and also any water specifically added during melt processing.

C. Plasticizer

Although not required, a plasticizer may be used in certain embodiments of the present invention to help lower the viscosity of the biodegradable polyester and improve its flexibility. Plasticizers are liquid, semi-solid, or solid having a relatively low molecular weight, such as from about 200 to about 10,000, in some embodiments, from about 300 to about 9,000, and in some embodiments, from about 500 to about 8,500. Any plasticizer that is compatible with the selected biodegradable polyester may generally be employed in the present invention, such as phthalates; esters (e.g., phosphate esters, ether diesters, carboxylic esters, epoxidized esters, aliphatic diesters, polyesters, copolyesters, etc.); alkylene glycols (e.g., ethylene glycol, diethylene glycol, triethylene glycol, tetraethylene glycol, propylene glycol, polyethylene glycol, polypropylene glycol, polybutylene glycol, etc.); alkane diols (e.g., 1,3-propanediol, 2,2-dimethyl-1,3-propanediol, 1,3-butanediol, 1,4-butanediol, 1,5-pentanediol, 1,6-hexanediol, 2,2,4-trimethyl-1,6-hexanediol, 1,3-cyclohexanedimethanol, 1,4-cyclohexanedimethanol, 2,2,4,4-tetramethyl-1,3-cyclobutanediol, etc.); alkylene oxides (e.g., polyethylene oxide, polypropylene oxide, etc.); and so forth. Certain plasticizers, such as alkylene glycols, alkane diols, alkylene oxides, etc., may possess one or more hydroxyl groups that can also attack the ester linkages of the biodegradable polyester and result in chain scission. In this manner, such plasticizers may not only improve the flexibility of the polyester, but they may also facilitate the hydrolysis reaction described above. Polyethylene glycol (“PEG”), for instance, is an example of a plasticizer that is particularly effective in facilitating the hydrolytic degradation of the biodegradable polyester. Suitable PEGs are commercially available from a variety of sources under designations such as PEG 600, PEG 8000, etc. Examples of such PEGs include Carbowax™, which is available from Dow Chemical Co. of Midland, Mich.

When employed, plasticizer(s) may be present in an amount of about 0.1 wt. % to about 20 wt. %, in some embodiments from about 0.2 wt. % to about 10 wt. %, and in some embodiments, from about 0.5 wt. % to about 5 wt. %, based on the dry weight of the starting biodegradable polyester. It should be understood, however, that a plasticizer is not required. In fact, in some embodiments of the present invention, the reactive composition is substantially free of any plasticizers, e.g., less than about 0.5 wt. % based on the dry weight of the starting biodegradable polyester.

D. Other Components

Other components may of course be utilized for a variety of different reasons. For instance, a wetting agent may be employed in some embodiments of the present invention to improve hydrophilicity. Wetting agents suitable for use in the present invention are generally compatible with biodegradable polyesters. Examples of suitable wetting agents may include surfactants, such as UNITHOX® 480 and UNITHOX® 750 ethoxylated alcohols, or UNICID™ acid amide ethoxylates, all available from Petrolite Corporation of Tulsa, Okla. Other suitable wetting agents are described in U.S. Pat. No. 6,177,193 to Tsai, et al., which is incorporated herein in its entirety by reference thereto for all relevant purposes. Still other materials that may be used include, without limitation, melt stabilizers, processing stabilizers, heat stabilizers, light stabilizers, antioxidants, pigments, surfactants, waxes, flow promoters, particulates, and other materials added to enhance processability. When utilized, such additional ingredients are each typically present in an amount of less than about 5 wt. %, in some embodiments less than about 1 wt. %, and in some embodiments, less than about 0.5 wt. %, based on the dry weight of the starting biodegradable polyester.

### II. Reaction Technique

The hydrolysis reaction may be performed using any of a variety of known techniques. In one embodiment, for example, the reaction is conducted while the starting polymer is in the melt phase (“melt processing”) to minimize the need for additional solvents and/or solvent removal processes. The raw materials (e.g., biodegradable polyester, water, etc.) may be supplied separately or in combination (e.g., in a solution). The raw materials may likewise be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., ZSK-30 twin-screw extruder available from Werner & Pfleiderer Corporation of Ramsey, N.J.). Such extruders may include feeding and venting ports and provide high intensity distributive and dispersive mixing, which facilitate the hydrolysis reaction. For example, the starting biodegradable polyester may be fed to a feeding port of the twin-screw extruder and melted. If desired, water may be thereafter injected into the polymer melt and/or separately fed into the extruder at a different point along its length. Alternatively, the biodegradable polyester may simply be supplied in a pre-humidified state.

Regardless of the particular melt processing technique chosen, the raw materials are blended under high shear/pressure and heat to ensure initiation of the hydrolysis reaction. For example, melt processing may occur at a temperature of from about 100° C. to about 500° C., in some embodiments, from about 150° C. to about 350° C., and in some embodiments, from about 175° C. to about 300° C. Likewise, the apparent shear rate during melt processing may range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4 Q/πR³, where Q is the volumetric flow rate (“m³/s”) of the polymer melt and R is the radius (“m”) of the capillary (e.g., extruder die) through which the melted polymer flows. Of course, other variables, such as the residence time during melt processing, which is inversely proportional to throughput rate, may also be controlled to achieve the desired degree of hydrolysis.

Under appropriate temperature and shear conditions, as described above, a hydrolytically degraded polyester species is formed that has a molecular weight lower than that of the starting polyester. The weight average and/or number average molecular weights may, for instance, each be reduced so that the ratio of the starting polyester molecular weight to the new molecular weight is at least about 1.1, in some embodiments at least about 1.4, and in some embodiments, at least about 1.6. For example, the hydrolytically degraded polyester may have a number average molecular weight (“Mₙ”) ranging from about 10,000 to about 70,000 grams per mole, in some embodiments from about 20,000 to about 60,000 grams per mole, and in some embodiments, from about 30,000 to about 55,000 grams per mole. Likewise, the hydrolytically degraded polyester may also have a weight average molecular weight (“M_{w}”) of from about 20,000 to about 125,000 grams per mole, in some embodiments from about 30,000 to about 110,000 grams per mole, and in some embodiments, from about 40,000 to about 90,000 grams per mole.

In addition to possessing a lower molecular weight, the hydrolytically degraded polyester may also have a lower apparent viscosity and higher melt flow rate than the starting polyester. The apparent viscosity may for instance, be reduced so that the ratio of the starting polyester viscosity to the hydrolytically degraded polyester viscosity is at least about 1.1, in some embodiments at least about 2, and in some embodiments, from about 15 to about 100. Likewise, the melt flow rate may be increased so that the ratio of the hydrolytically degraded polyester melt flow rate to the starting polyester melt flow rate (on a dry basis) is at least about 1.5, in some embodiments at least about 5, in some embodiments at least about 10, and in some embodiments, from about 30 to about 100. In one particular embodiment, the hydrolytically degraded polyester may have an apparent viscosity of from about 10 to about 500 Pascal seconds (Pa·s), in some embodiments from about 20 to about 400 Pa·s, and in some embodiments, from about 30 to about 250 Pa·s, as determined at a temperature of 170° C. and a shear rate of 1000 sec⁻¹. The melt flow rate (190° C., 2.16 kg, dry basis) of the hydrolytically degraded polyester may range from about 10 to about 1000 grams per 10 minutes, in some embodiments from about 20 to about 900 grams per 10 minutes, and in some embodiments, from about 100 to about 800 grams per 10 minutes (190° C., 2.16 kg). Of course, the extent to which the molecular weight, apparent viscosity, and/or melt flow rate are altered by the hydrolysis reaction may vary depending on the intended application.

Although differing from the starting polymer in certain properties, the hydrolytically degraded polyester may nevertheless retain other properties of the starting polymer to enhance the flexibility and processability of the polymers. For example, the thermal characteristics (e.g., T_{g}, Tₘ, and latent heat of fusion) typically remain substantially the same as the starting polymer, such as within the ranges noted above. Further, even though the actual molecular weights may differ, the polydispersity index of the hydrolytically degraded polyester may remain substantially the same as the starting polymer, such as within the range of about 1.0 to about 3.5, in some embodiments from about 1.1 to about 2.5, and in some embodiments, from about 1.2 to about 2.0.

### III. Fiber Formation

Fibers formed from the hydrolytically degraded polyester may generally have any desired configuration, including monocomponent, multicomponent (e.g., sheath-core configuration, side-by-side configuration, segmented pie configuration, island-in-the-sea configuration, and so forth), and/or multiconstituent (e.g., polymer blend). In some embodiments, the fibers may contain one or more additional polymers as a component (e.g., bicomponent) or constituent (e.g., biconstituent) to further enhance strength and other mechanical properties. For instance, the hydrolytically degraded polyester may form a sheath component of a sheath/core bicomponent fiber, while an additional polymer may form the core component, or vice versa. The additional polymer may be a thermoplastic polymer that is not generally considered biodegredable, such as polyolefins, e.g., polyethylene, polypropylene, polybutylene, and so forth; polytetrafluoroethylene; polyesters, e.g., polyethylene terephthalate, and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; and polyurethanes. More desirably, however, the additional polymer is biodegredable, such as aliphatic polyesters, such as polyesteramides, modified polyethylene terephthalate, polylactic acid (PLA) and its copolymers, terpolymers based on polylactic acid, polyglycolic acid, polyalkylene carbonates (such as polyethylene carbonate), polyhydroxyalkanoates (PHA), polyhydroxybutyrates (PHB), polyhydroxyvalerates (PHV), polyhydroxybutyrate-hydroxyvalerate copolymers (PHBV), and polycaprolactone, and succinate-based aliphatic polymers (e.g., polybutylene succinate, polybutylene succinate adipate, and polyethylene succinate); aromatic polyesters; or other aliphatic-aromatic copolyesters.

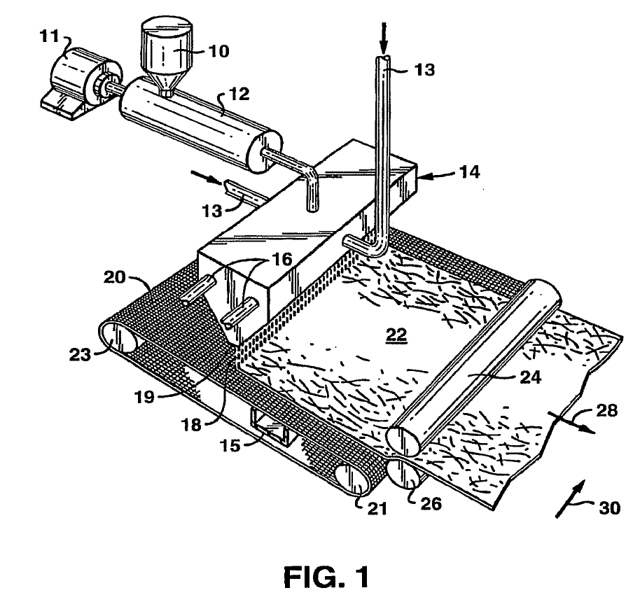

Any of a variety of processes may be used to form fibers in accordance with the present invention. Referring to FIG. 1, for example, one embodiment of a method for forming meltblown fibers is shown. Meltblown fibers form a structure having a small average pore size, which may be used to inhibit the passage of liquids and particles, while allowing gases (e.g., air and water vapor) to pass therethrough. To achieve the desired pore size, the meltblown fibers are typically “microfibers” in that they have an average size of 10 micrometers or less, in some embodiments about 7 micrometers or less, and in some embodiments, about 5 micrometers or less. The ability to produce such fine fibers may be facilitated in the present invention through the use of a hydrolytically degraded polyester having the desirable combination of low apparent viscosity and high melt flow rate.

In FIG. 1, for instance, the raw materials (e.g., polymer, plasticizer, etc.) are fed into an extruder 12 from a hopper 10. The raw materials may be provided to the hopper 10 using any conventional technique and in any state. Alternatively, the biodegradable polyester may be fed to the hopper 10, and the glycol may be injected into the polyester melt in the extruder 12 downstream from the hopper 10. The extruder 12 is driven by a motor 11 and heated to a temperature sufficient to extrude the polymer and to initiate the hydrolysis reaction. For example, the extruder 12 may employ one or multiple zones operating at a temperature of from about 100° C. to about 500° C., in some embodiments, from about 150° C. to about 350° C., and in some embodiments, from about 175° C. to about 300° C. Typical shear rates range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. If desired, the extruder may also possess one or more zones that remove excess moisture from the polymer, such as vacuum zones, etc. The extruder may also be vented to allow volatile gases to escape.

Once formed, the hydrolytically degraded polyester may be subsequently fed to another extruder in a fiber formation line (e.g., extruder 12 of a meltblown spinning line). Alternatively, the hydrolytically degraded polymer may be directly formed into a fiber through supply to a die 14, which may be heated by a heater 16. It should be understood that other meltblown die tips may also be employed. As the polymer exits the die 14 at an orifice 19, high pressure fluid (e.g., heated air) supplied by conduits 13 attenuates and spreads the polymer stream into microfibers 18. Although not shown in FIG. 1, the die 14 may also be arranged adjacent to or near a chute through which other materials (e.g., cellulosic fibers, particles, etc.) traverse to intermix with the extruded polymer and form a “coform” web.

The microfibers 18 are randomly deposited onto a foraminous surface 20 (driven by rolls 21 and 23) with the aid of an optional suction box 15 to form a meltblown web 22. The distance between the die tip and the foraminous surface 20 is generally small to improve the uniformity of the fiber laydown. For example, the distance may be from about 1 to about 35 centimeters, and in some embodiments, from about 2.5 to about 15 centimeters. In FIG. 1, the direction of the arrow 28 shows the direction in which the web is formed (i.e., “machine direction”) and arrow 30 shows a direction perpendicular to the machine direction (i.e., “cross-machine direction”). Optionally, the meltblown web 22 may then be compressed by rolls 24 and 26. The desired denier of the fibers may vary depending on the desired application. Typically, the fibers are formed to have a denier per filament (i.e., the unit of linear density equal to the mass in grams per 9000 meters of fiber) of less than about 6, in some embodiments less than about 3, and in some embodiments, from about 0.5 to about 3. In addition, the fibers generally have an average diameter of from about 0.1 to about 20 micrometers, in some embodiments from about 0.5 to about 15 micrometers, and in some embodiments, from about 1 to about 10 micrometers.

Once formed, the nonwoven web may then be bonded using any conventional technique, such as with an adhesive or autogenously (e.g., fusion and/or self-adhesion of the fibers without an applied external adhesive). Autogenous bonding, for instance, may be achieved through contact of the fibers while they are semi-molten or tacky, or simply by blending a tackifying resin and/or solvent with the polylactic acid(s) used to form the fibers. Suitable autogenous bonding techniques may include ultrasonic bonding, thermal bonding, through-air bonding, calendar bonding, and so forth. For example, the web may be further bonded or embossed with a pattern by a thermo-mechanical process in which the web is passed between a heated smooth anvil roll and a heated pattern roll. The pattern roll may have any raised pattern which provides the desired web properties or appearance. Desirably, the pattern roll defines a raised pattern which defines a plurality of bond locations which define a bond area between about 2% and 30% of the total area of the roll. Exemplary bond patterns include, for instance, those described in U.S. Pat. No. 3,855,046 to Hansen et al., U.S. Pat. No. 5,620,779 to Levy et al., U.S. Pat. No. 5,962,112 to Haynes et al., U.S. Pat. No. 6,093,665 to Sayovitz et al., as well as U.S. Design Pat. Nos. 428,267 to Romano et al.; 390,708 to Brown; 418,305 to Zander, et al.; 384,508 to Zander, et al.; 384,819 to Zander, et al.; 358,035 to Zander. et al.; and 315,990 to Blenke. et al., all of which are incorporated herein in their entirety by reference thereto for all purposes. The pressure between the rolls may be from about 5 to about 2000 pounds per lineal inch. The pressure between the rolls and the temperature of the rolls is balanced to obtain desired web properties or appearance while maintaining cloth like properties. As is well known to those skilled in the art, the temperature and pressure required may vary depending upon many factors including but not limited to, pattern bond area, polymer properties, fiber properties and nonwoven properties.

In addition to meltblown webs, a variety of other nonwoven webs may also be formed from the hydrolytically degraded polyester in accordance with the present invention, such as spunbond webs, bonded carded webs, wet-laid webs, airlaid webs, coform webs, hydraulically entangled webs, etc. For example, the polymer may be extruded through a spinnerette, quenched and drawn into substantially continuous filaments, and randomly deposited onto a forming surface. Alternatively, the polymer may be formed into a carded web by placing bales of fibers formed from the blend into a picker that separates the fibers. Next, the fibers are sent through a combing or carding unit that further breaks apart and aligns the fibers in the machine direction so as to form a machine direction-oriented fibrous nonwoven web. Once formed, the nonwoven web is typically stabilized by one or more known bonding techniques.

If desired, the nonwoven web may also be a composite that contains a combination of the hydrolytically degraded polyester fibers and other types of fibers (e.g., staple fibers, filaments, etc). For example, additional synthetic fibers may be utilized, such as those formed from polyolefins, e.g., polyethylene, polypropylene, polybutylene, and so forth; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; etc. If desired, biodegradable polymers, such as poly(glycolic acid) (PGA), poly(lactic acid) (PLA), poly(ε-malic acid) (PMLA), poly(ε-caprolactone) (PCL), poly(ρ-dioxanone) (PDS), poly(butylene succinate) (PBS), and poly(3-hydroxybutyrate) (PHB), may also be employed. Some examples of known synthetic fibers include sheath-core bicomponent fibers available from KoSa Inc. of Charlotte, N.C. under the designations T-255 and T-256, both of which use a polyolefin sheath, or T-254, which has a low melt co-polyester sheath. Still other known bicomponent fibers that may be used include those available from the Chisso Corporation of Moriyama, Japan or Fibervisions LLC of Wilmington, Del. Polylactic acid staple fibers may also be employed, such as those commercially available from Far Eastern Textile, Ltd. of Taiwan.

The composite may also contain pulp fibers, such as high-average fiber length pulp, low-average fiber length pulp, or mixtures thereof. One example of suitable high-average length fluff pulp fibers includes softwood kraft pulp fibers. Softwood kraft pulp fibers are derived from coniferous trees and include pulp fibers such as, but not limited to, northern, western, and southern softwood species, including redwood, red cedar, hemlock, Douglas fir, true firs, pine (e.g., southern pines), spruce (e.g., black spruce), combinations thereof, and so forth. Northern softwood kraft pulp fibers may be used in the present invention. An example of commercially available southern softwood kraft pulp fibers suitable for use in the present invention include those available from Weyerhaeuser Company with offices in Federal Way, Wash. under the trade designation of “NF-405.” Another suitable pulp for use in the present invention is a bleached, sulfate wood pulp containing primarily softwood fibers that is available from Bowater Corp. with offices in Greenville, S.C. under the trade name CoosAbsorb S pulp. Low-average length fibers may also be used in the present invention. An example of suitable low-average length pulp fibers is hardwood kraft pulp fibers. Hardwood kraft pulp fibers are derived from deciduous trees and include pulp fibers such as, but not limited to, eucalyptus, maple, birch, aspen, etc. Eucalyptus kraft pulp fibers may be particularly desired to increase softness, enhance brightness, increase opacity, and change the pore structure of the sheet to increase its wicking ability.

Nonwoven composites may be formed using a variety of known techniques. For example, the nonwoven composite may be a “coform material” that contains a mixture or stabilized matrix of the hydrolytically degraded polylactic fibers and an absorbent material. As an example, coform materials may be made by a process in which at least one meltblown die head is arranged near a chute through which the absorbent materials are added to the web while it is forming. Such absorbent materials may include, but are not limited to, pulp fibers, superabsorbent particles, inorganic and/or organic absorbent materials, treated polymeric staple fibers, and so forth. The relative percentages of the absorbent material may vary over a wide range depending on the desired characteristics of the nonwoven composite. For example, the nonwoven composite may contain from about 1 wt. % to about 60 wt. %, in some embodiments from 5 wt. % to about 50 wt. %, and in some embodiments, from about 10 wt. % to about 40 wt. % hydrolytically degraded polyester fibers. The nonwoven composite may likewise contain from about 40 wt. % to about 99 wt. %, in some embodiments from 50 wt. % to about 95 wt. %, and in some embodiments, from about 60 wt. % to about 90 wt. % absorbent material. Some examples of such coform materials are disclosed in U.S. Pat. Nos. 4,100,324 to Anderson. et al.; 5,284,703 to Everhart. et al.; and 5,350,624 to Georger et al.; which are incorporated herein in their entirety by reference thereto for all purposes.

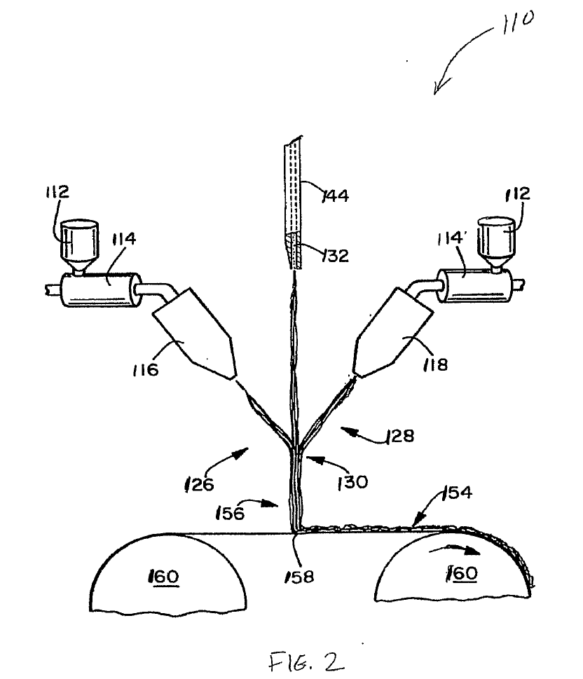

Referring to FIG. 2, for example, one embodiment of an apparatus for forming a nonwoven coform composite structure is generally represented by reference numeral 110. Initially, the raw materials (e.g., polyester acid, etc.) are supplied to a hopper 112 of an extruder 114, and then extruded toward two meltblowing dies 116 and 118 corresponding to a stream of gas 126 and 128, respectively, which are aligned to converge at an impingement zone 130. One or more types of a secondary material 132 (fibers and/or particulates) are also supplied by a nozzle 144 and added to the two streams 126 and 128 at the impingement zone 130 to produce a graduated distribution of the material within the combined streams 126 and 128. The secondary material may be supplied using any known technique in the art, such as with a picker roll arrangement (not shown) or a particulate injection system (not shown). The secondary stream 132 merges with the two streams 126 and 128 to form a composite stream 156. An endless belt 158 driven by rollers 160 receives the stream 156 and form a composite structure 154. If desired, vacuum boxes (not shown) may be employed to assist in retention of the matrix on the surface of the belt 158.

Nonwoven laminates may also be formed in which one or more layers are formed from the hydrolytically degraded polyester of the present invention. For example, the nonwoven web of one layer may be a meltblown or coform web that contains the hydrolytically degraded polyester, while the nonwoven web of another layer contains hydrolytically degraded polyester, other biodegradable polymer(s), and/or any other polymer (e.g., polyolefins). In one embodiment, the nonwoven laminate contains a meltblown layer positioned between two spunbond layers to form a spunbond/meltblown/spunbond (“SMS”) laminate. If desired, the meltblown layer may be formed from the hydrolytically degraded polyester. The spunbond layer may be formed from the hydrolytically degraded polyester, other biodegradable polymer(s), and/or any other polymer (e.g., polyolefins). Various techniques for forming SMS laminates are described in U.S. Pat. Nos. 4,041,203 to Brock et al.; 5,213,881 to Timmons. et al.; 5,464,688 to Timmons, et al.; 4,374,888 to Bornslaeger; 5,169,706 to Collier, et al.; and 4,766,029 to Brock et al., as well as U.S. Patent Application Publication No. 2004/0002273 to Fitting, et al., all of which are incorporated herein in their entirety by reference thereto for all purposes. Of course, the nonwoven laminate may have other configuration and possess any desired number of meltblown and spunbond layers, such as spunbond/meltblown/meltblown/spunbond laminates (“SMMS”), spunbond/meltblown laminates (“SM”), etc. Although the basis weight of the nonwoven laminate may be tailored to the desired application, it generally ranges from about 10 to about 300 grams per square meter (“gsm”), in some embodiments from about 25 to about 200 gsm, and in some embodiments, from about 40 to about 150 gsm.

If desired, the nonwoven web or laminate may be applied with various treatments to impart desirable characteristics. For example, the web may be treated with liquid-repellency additives, antistatic agents, surfactants, colorants, antifogging agents, fluorochemical blood or alcohol repellents, lubricants, and/or antimicrobial agents. In addition, the web may be subjected to an electret treatment that imparts an electrostatic charge to improve filtration efficiency. The charge may include layers of positive or negative charges trapped at or near the surface of the polymer, or charge clouds stored in the bulk of the polymer. The charge may also include polarization charges that are frozen in alignment of the dipoles of the molecules. Techniques for subjecting a fabric to an electret treatment are well known by those skilled in the art. Examples of such techniques include, but are not limited to, thermal, liquid-contact, electron beam and corona discharge techniques. In one particular embodiment, the electret treatment is a corona discharge technique, which involves subjecting the laminate to a pair of electrical fields that have opposite polarities. Other methods for forming an electret material are described in U.S. Pat. Nos. 4,215,682 to Kubik. et al.; 4,375,718 to Wadsworth; 4,592,815 to Nakao; 4,874,659 to Ando; 5,401,446 to Tsai, et al.; 5,883,026 to Reader, et al.; 5,908,598 to Rousseau. et al.; 6,365,088 to Knight, et al., which are incorporated herein in their entirety by reference thereto for all purposes.

### IV. Articles

The nonwoven web of the present invention may be used in a wide variety of applications. For example, the web may be incorporated into a “medical product”, such as gowns, surgical drapes, facemasks, head coverings, surgical caps, shoe coverings, sterilization wraps, warming blankets, heating pads, and so forth. Of course, the nonwoven web may also be used in various other articles. For example, the nonwoven web may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth.

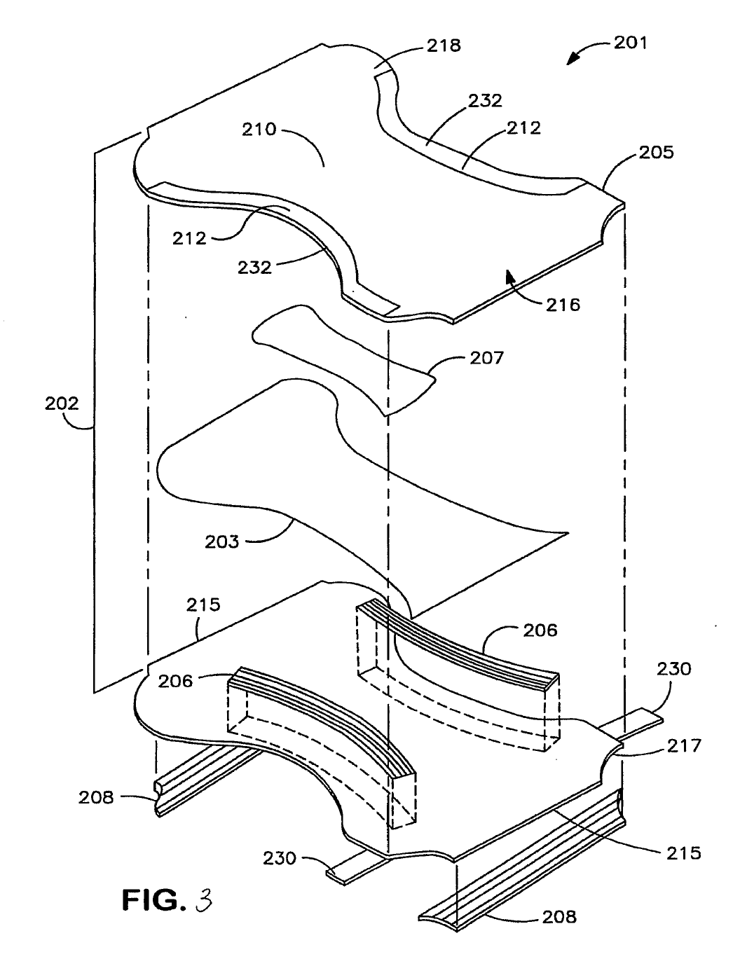

Materials and processes suitable for forming such articles are well known to those skilled in the art. Absorbent articles, for instance, typically include a substantially liquid-impermeable layer (e.g., backsheet), a liquid-permeable layer (e.g., top sheet, surge management layer, ventilation layer, wrap, etc.), and an absorbent core. Referring to FIG. 3, for instance, one embodiment of an absorbent article 201 is shown in the form of a diaper. However, as noted above, the invention may be embodied in other types of absorbent articles, such as incontinence articles, sanitary napkins, diaper pants, feminine napkins, children's training pants, and so forth. In the illustrated embodiment, the diaper 201 is shown as having an hourglass shape in an unfastened configuration. However, other shapes may of course be utilized, such as a generally rectangular shape, T-shape, or I-shape. As shown, the diaper 201 includes a chassis 202 formed by various components, including an outer cover 217, bodyside liner 205, absorbent core 203, and surge layer 207. It should be understood, however, that other layers may also be used in the present invention. Likewise, one or more of the layers referred to in FIG. 3 may also be eliminated in certain embodiments of the present invention.

The outer cover 217 is typically formed from a material that is substantially impermeable to liquids. For example, the outer cover 217 may be formed from a thin plastic film or other flexible liquid-impermeable material. In one embodiment, the outer cover 217 is formed from a polyethylene film having a thickness of from about 0.01 millimeter to about 0.05 millimeter. The film may be impermeable to liquids, but permeable to gases and water vapor (i.e., “breathable”). This permits vapors to escape from the absorbent core 203, but still prevents liquid exudates from passing through the outer cover 217. If a more cloth-like feeling is desired, the outer cover 217 may be formed from a polyolefin film laminated to a nonwoven web. For example, a stretch-thinned polypropylene film having a thickness of about 0.015 millimeter may be thermally laminated to a spunbond web of polypropylene fibers. If desired, the nonwoven web may contain the fibers of the present invention.

The diaper 201 also includes a bodyside liner 205. The bodyside liner 205 is generally employed to help isolate the wearer's skin from liquids held in the absorbent core 203. For example, the liner 205 presents a bodyfacing surface that is typically compliant, soft feeling, and non-irritating to the wearer's skin. Typically, the liner 205 is also less hydrophilic than the absorbent core 203 so that its surface remains relatively dry to the wearer. The liner 205 may be liquid-permeable to permit liquid to readily penetrate through its thickness. In one particular embodiment, the liner includes a nonwoven web (e.g., spunbond web, meltblown web, or bonded carded web) containing the multicomponent fibers of the present invention. Exemplary liner constructions that contain a nonwoven web are described in U.S. Pat. Nos. 5,192,606; 5,702,377; 5,931,823; 6,060,638; and 6,150,002, as well as U.S. Patent Application Publication Nos. 2004/0102750, 2005/0054255, and 2005/0059941, all of which are incorporated herein in their entirety by reference thereto for all purposes.

As illustrated in FIG. 3, the diaper 201 may also include a surge layer 207 that helps to decelerate and diffuse surges or gushes of liquid that may be rapidly introduced into the absorbent core 203. Desirably, the surge layer 207 rapidly accepts and temporarily holds the liquid prior to releasing it into the storage or retention portions of the absorbent core 203. In the illustrated embodiment, for example, the surge layer 207 is interposed between an inwardly facing surface 216 of the bodyside liner 205 and the absorbent core 203. Alternatively, the surge layer 207 may be located on an outwardly facing surface 218 of the bodyside liner 205. The surge layer 207 is typically constructed from highly liquid-permeable materials. Suitable materials may include porous woven materials, porous nonwoven materials, and apertured films. In one particular embodiment, the surge layer 207 includes a nonwoven web containing the fibers of the present invention. Other examples of suitable surge layers are described in U.S. Pat. Nos. 5,486,166 to Ellis, et al. and 5,490,846 to Ellis, et al., which are incorporated herein in their entirety by reference thereto for all purposes.

Besides the above-mentioned components, the diaper 201 may also contain various other components as is known in the art. For example, the diaper 201 may also contain a substantially hydrophilic wrapsheet (not illustrated) that helps maintain the integrity of the fibrous structure of the absorbent core 203. The wrapsheet is typically placed about the absorbent core 203 over at least the two major facing surfaces thereof, and composed of an absorbent cellulosic material, such as creped wadding or a high wet-strength tissue. The wrapsheet may be configured to provide a wicking layer that helps to rapidly distribute liquid over the mass of absorbent fibers of the absorbent core 203. The wrapsheet material on one side of the absorbent fibrous mass may be bonded to the wrapsheet located on the opposite side of the fibrous mass to effectively entrap the absorbent core 203. If desired, the wrapsheet may be formed from a nonwoven web that includes the fibers of the present invention.

Furthermore, the diaper 201 may also include a ventilation layer (not shown) that is positioned between the absorbent core 203 and the outer cover 217. When utilized, the ventilation layer may help insulate the outer cover 217 from the absorbent core 203, thereby reducing dampness in the outer cover 217. Examples of such ventilation layers may include a nonwoven web laminated to a breathable film, such as described in U.S. Pat. No. 6,663,611 to Blaney, et al., which is incorporated herein in its entirety by reference thereto for all purpose. Such nonwoven webs may be formed from a nonwoven web that includes the fibers of the present invention.

In some embodiments, the diaper 201 may also include a pair of ears (not shown) that extend from the side edges 232 of the diaper 201 into one of the waist regions. The ears may be integrally formed with a selected diaper component. For example, the ears may be integrally formed with the outer cover 217 or from the material employed to provide the top surface. In alternative configurations, the ears may be provided by members connected and assembled to the outer cover 217, the top surface, between the outer cover 217 and top surface, or in various other configurations.

As representatively illustrated in FIG. 3, the diaper 201 may also include a pair of containment flaps 212 that are configured to provide a barrier and to contain the lateral flow of body exudates. The containment flaps 212 may be located along the laterally opposed side edges 232 of the bodyside liner 205 adjacent the side edges of the absorbent core 203. The containment flaps 212 may extend longitudinally along the entire length of the absorbent core 203, or may only extend partially along the length of the absorbent core 203. When the containment flaps 212 are shorter in length than the absorbent core 203, they may be selectively positioned anywhere along the side edges 232 of diaper 201 in a crotch region 210. In one embodiment, the containment flaps 212 extend along the entire length of the absorbent core 203 to better contain the body exudates. Such containment flaps 212 are generally well known to those skilled in the art. For example, suitable constructions and arrangements for the containment flaps 212 are described in U.S. Pat. No. 4,704,116 to Enloe, which is incorporated herein in its entirety by reference thereto for all purposes. If desired, one or more of the containment flaps 212 may be formed from a nonwoven web that includes the fibers of the present invention.

The diaper 201 may include various elastic or stretchable materials, such as a pair of leg elastic members 206 affixed to the side edges 232 to further prevent leakage of body exudates and to support the absorbent core 203. In addition, a pair of waist elastic members 208 may be affixed to longitudinally opposed waist edges 215 of the diaper 201. The leg elastic members 206 and the waist elastic members 208 are generally adapted to closely fit about the legs and waist of the wearer in use to maintain a positive, contacting relationship with the wearer and to effectively reduce or eliminate the leakage of body exudates from the diaper 201. As used herein, the terms “elastic” and “stretchable” include any material that may be stretched and return to its original shape when relaxed Suitable polymers for forming such materials include, but are not limited to, block copolymers of polystyrene, polyisoprene and polybutadiene; copolymers of ethylene, natural rubbers and urethanes; etc. Particularly suitable are styrene-butadiene block copolymers sold by Kraton Polymers of Houston, Tex. under the trade name Kraton®. Other suitable polymers include copolymers of ethylene, including without limitation ethylene vinyl acetate, ethylene methyl acrylate, ethylene ethyl acrylate, ethylene acrylic acid, stretchable ethylene-propylene copolymers, and combinations thereof. Also suitable are coextruded composites of the foregoing, and elastomeric staple integrated composites where staple fibers of polypropylene, polyester, cotton and other materials are integrated into an elastomeric meltblown web. Certain elastomeric single-site or metallocene-catalyzed olefin polymers and copolymers are also suitable for the side panels.

The diaper 201 may also include one or more fasteners 230. For example, two flexible fasteners 130 are illustrated in FIG. 3 on opposite side edges of waist regions to create a waist opening and a pair of leg openings about the wearer. The shape of the fasteners 230 may generally vary, but may include, for instance, generally rectangular shapes, square shapes, circular shapes, triangular shapes, oval shapes, linear shapes, and so forth. The fasteners may include, for instance, a hook material. In one particular embodiment, each fastener 230 includes a separate piece of hook material affixed to the inside surface of a flexible backing.

The various regions and/or components of the diaper 201 may be assembled together using any known attachment mechanism, such as adhesive, ultrasonic, thermal bonds, etc. Suitable adhesives may include, for instance, hot melt adhesives, pressure-sensitive adhesives, and so forth. When utilized, the adhesive may be applied as a uniform layer, a patterned layer, a sprayed pattern, or any of separate lines, swirls or dots. In the illustrated embodiment, for example, the outer cover 217 and bodyside liner 205 are assembled to each other and to the absorbent core 203 using an adhesive. Alternatively, the absorbent core 203 may be connected to the outer cover 217 using conventional fasteners, such as buttons, hook and loop type fasteners, adhesive tape fasteners, and so forth. Similarly, other diaper components, such as the leg elastic members 206, waist elastic members 208 and fasteners 230, may also be assembled into the diaper 201 using any attachment mechanism.

Although various configurations of a diaper have been described above, it should be understood that other diaper and absorbent article configurations are also included within the scope of the present invention. In addition, the present invention is by no means limited to diapers. In fact, any other absorbent article may be formed in accordance with the present invention, including, but not limited to, other personal care absorbent articles, such as training pants, absorbent underpants, adult incontinence products, feminine hygiene products (e.g., sanitary napkins), swim wear, baby wipes, and so forth; medical absorbent articles, such as garments, fenestration materials, underpads, bandages, absorbent drapes, and medical wipes; food service wipers; clothing articles; and so forth.

In one embodiment, for example, the nonwoven web of the present invention may be used to form a wipe configured for use on skin, such as a baby wipe, adult wipe, hand wipe, face wipe, cosmetic wipe, household wipe, industrial wipe, personal cleansing wipe, cotton ball, cotton-tipped swab, and so forth. The wipe may assume a variety of shapes, including but not limited to, generally circular, oval, square, rectangular, or irregularly shaped. Each individual wipe may be arranged in a folded configuration and stacked one on top of the other to provide a stack of wet wipes. Such folded configurations are well known to those skilled in the art and include c-folded, z-folded, quarter-folded configurations and so forth. For example, the wipe may have an unfolded length of from about 2.0 to about 80.0 centimeters, and in some embodiments, from about 10.0 to about 25.0 centimeters. The wipes may likewise have an unfolded width of from about 2.0 to about 80.0 centimeters, and in some embodiments, from about 10.0 to about 25.0 centimeters. The stack of folded wipes may be placed in the interior of a container, such as a plastic tub, to provide a package of wipes for eventual sale to the consumer. Alternatively, the wipes may include a continuous strip of material which has perforations between each wipe and which may be arranged in a stack or wound into a roll for dispensing. Various suitable dispensers, containers, and systems for delivering wipes are described in U.S. Pat. Nos. 5,785,179 to Buczwinski. et al.; 5,964,351 to Zander; 6,030,331 to Zander; 6,158,614 to Haynes, et al.; 6,269,969 to Huang. et al.; 6,269,970 to Huang, et al.; and 6,273,359 to Newman, et al., which are incorporated herein in their entirety by reference thereto for all purposes.

In certain embodiments of the present invention, the wipe is a “wet wipe” in that it contains a solution for cleaning, disinfecting, sanitizing, etc. The particular wet wipe solutions are not critical to the present invention and are described in more detail in U.S. Pat. Nos. 6,440,437 to Krzysik, et al.; 6,028,018 to Amundson, et al.; 5,888,524 to Cole; 5,667,635 to Win, et al.; 5,540,332 to Kopacz, et al.; and 4,741,944 to Jackson, et al., which are incorporated herein in their entirety by reference thereto for all purposes. The amount of the wet wipe solution employed may depending upon the type of wipe material utilized, the type of container used to store the wipes, the nature of the cleaning formulation, and the desired end use of the wipes. Generally, each wipe contains from about 150 to about 600 wt. % and desirably from about 300 to about 500 wt. % of a wet wipe solution based on the dry weight of the wipe.

The present invention may be better understood with reference to the following examples.

### Test Methods

Molecular Weight

The molecular weight distribution of a polymer was determined by gel permeation chromatography (“GPC”). The samples were initially prepared by adding 0.5% wt/v solutions of the sample polymers in chloroform to 40-milliliter glass vials. For example, 0.05±0.0005 grams of the polymer was added to 10 milliliters of chloroform. The prepared samples were placed on an orbital shaker and agitated overnight. The dissolved sample was filtered through a 0.45-micrometer PTFE membrane and analyzed using the following conditions:
Columns: Styragel HR 1, 2, 3, 4, & 5E (5 in series) at 41° C.
Solvent/Eluent: Chloroform@1.0 milliliter per minute
HPLC: Waters 600E gradient pump and controller, Waters 717 auto sampler
Detector: Waters 2414 Differential Refractometer at sensitivity=30, at 40° C. and scale factor of 20
Sample Concentration: 0.5% of polymer “as is”
Injection Volume: 50 microliters
Calibration Standards Narrow MW polystyrene, 30-microliter injected volume.

Number Average Molecular Weight (MWₙ), Weight Average Molecular Weight (MW_{w}) and first moment of viscosity average molecular weight (MW_{z}) were obtained.

Apparent Viscosity:

The rheological properties of polymer samples were determined using a Göttfert Rheograph 2003 capillary rheometer with WinRHEO version 2.31 analysis software. The setup included a 2000-bar pressure transducer and a 30/1:0/180 roundhole capillary die. Sample loading was done by alternating between sample addition and packing with a ramrod. A 2-minute melt time preceded each test to allow the polymer to completely melt at the test temperature (usually 160 to 220° C.). The capillary rheometer determined the apparent viscosity (Pa·s) at various shear rates, such as 100, 200, 500, 1000, 2000, and 4000 s⁻¹. The resultant rheology curve of apparent shear rate versus apparent viscosity gave an indication of how the polymer would run at that temperature in an extrusion process.

Melt Flow Rate:

The melt flow rate (“MFR”) is the weight of a polymer (in grams) forced through an extrusion rheometer orifice (0.0825-inch diameter) when subjected to a load of 2160 grams in 10 minutes, typically at 190° C. or 230° C. Unless otherwise indicated, the melt flow rate was measured in accordance with ASTM Test Method D1238-E. The melt flow rate may be measured before or after drying. Polymers measured after drying (dry basis) generally have a water content of less than 500 parts per million.

Tensile Properties:

The strip tensile strength values were determined in substantial accordance with ASTM Standard D-5034. Specifically, a nonwoven web sample was cut or otherwise provided with size dimensions that measured 25 millimeters (width)×127 millimeters (length). A constant-rate-of-extension type of tensile tester was employed. The tensile testing system was a Sintech Tensile Tester, which is available from Sintech Corp. of Cary, N.C. The tensile tester was equipped with TESTWORKS 4.08B software from MTS Corporation to support the testing. An appropriate load cell was selected so that the tested value fell within the range of 10-90% of the full scale load. The sample was held between grips having a front and back face measuring 25.4 millimeters×76 millimeters. The grip faces were rubberized, and the longer dimension of the grip was perpendicular to the direction of pull. The grip pressure was pneumatically maintained at a pressure of 40 pounds per square inch. The tensile test was run at a 300-millimeter per minute rate with a gauge length of 10.16 centimeters and a break sensitivity of 40%.

Five samples were tested by applying the test load along the machine-direction (“MD”) and five samples were tested by applying the test load along the cross direction (“CD”). In addition to tensile strength (“peak load”) and peak elongation (i.e., % strain at peak load) were measured.

Water Content:

Water content was determined using an Arizona Instruments Computrac Vapor Pro moisture analyzer (Model No. 3100) in substantial accordance with ASTM D 7191-05, which is incorporated herein in its entirety by reference thereto for all purposes. The test temperature (§X2.1.2) was 130° C., the sample size (§X2.1.1) was 2 to 4 grams, and the vial purge time (§X2.1.4) was 30 seconds. Further, the ending criteria (§X2.1.3) was defined as a “prediction” mode, which means that the test is ended when the built-in programmed criteria (which mathematically calculates the end point moisture content) is satisfied.

### Example 1

Two grades of polyesters were employed, i.e., Ecoflex® FBX7011 supplied by BASF and Enpol™ G4560J supplied by Ire Chemical, Korea. Resins were formed as described below in Table 1 and melt processed using a Wernerer Phleiderer Model ZSK-30 twin screw extruder (L/D ratio of 44). A high shear screw setting was employed that included a total of 19 low shear conveying elements and a total of 39 high shear kneading elements. After extrusion, the modified polymer strands were cooled on a conveyor belt and pelletized. Resins were used both dry and pre-moisturized. Moisture content was measured prior to extrusion and resin was extruded using the melt processing conditions illustrated in Tables 2-3. Final moisture content and final melt flow rate (MFR) were measured after pelletization of the modified resin.

TABLE 1
Resin Content

| | | Additive | Initial Moisture level |
|---|---|---|---|
| Sample | Polymer | (wt. %) | (ppm) |
| 1 | Enpol G4560J | — | 484 |
| 2 | Enpol G4560J | — | 484 |
| 3 | Enpol G4560J | — | 484 |
| 4 | Enpol G4560J | — | 484 |
| 5 | Enpol G4560J | PEG 8000 | 484 |
| | | (10 wt. %) | |
| 6 | Ecoflex FBX7011 | — | 2217 |
| 7 | Ecoflex FBX7011 | — | 2217 |
| 8 | Ecoflex FBX7011 | — | 490 |
| 9 | Ecoflex FBX7011 | — | 490 |
| 10 | Ecoflex FBX7011 | — | 490 |
| 11 | Ecoflex FBX7011 | — | 2098 |
| 12 | Ecoflex FBX7011 | — | 2098 |
| 13 | Ecoflex FBX7011 | — | 257 |
| 14 | Ecoflex FBX7011 | PEG 8000 | 287 |
| | | (15%) | |
| 15 | Enpol G4560J | — | 2232 |
| 16 | PLA 6201D* (76.5 wt. %) | PEG 8000 | — |
| | Enpol G4560J (23.5 wt. %) | (15 wt. %) | |
| 17 | PLA 6201D* (64.7 wt. %) | PEG 8000 | — |
| | Enpol G4560J (35.3 wt. %) | (15 wt. %) | |

*PLA 6201D is a polylactic acid resin available from NatureWorks LLC.

TABLE 2
Extrusion Profile for Zones 1-7

| Sam- | Zone 1 | Zone 2 | Zone 3 | Zone 4 | Zone 5 | Zone 6 | Zone 7 |
|---|---|---|---|---|---|---|---|
| ple | (° F.) | (° F.) | (° F.) | (° F.) | (° F.) | (° F.) | (° F.) |
| 1 | — | — | — | — | — | — | — |
| 2 | 200 | 200 | 200 | 200 | 200 | 190 | 140 |
| 3 | 220 | 220 | 220 | 220 | 220 | 200 | 140 |
| 4 | 220 | 240 | 240 | 240 | 240 | 220 | 120 |
| 5 | 220 | 240 | 240 | 240 | 240 | 215 | 145 |
| 6 | — | — | — | — | — | — | — |
| 7 | 200 | 230 | 230 | 230 | 230 | 190 | 150 |
| 8 | — | — | — | — | — | — | — |
| 9 | 200 | 220 | 220 | 220 | 220 | 210 | 160 |
| 10 | 200 | 230 | 230 | 230 | 230 | 210 | 160 |
| 11 | — | — | — | — | — | — | — |
| 12 | 200 | 230 | 230 | 230 | 230 | 210 | 160 |
| 13 | 200 | 245 | 245 | 245 | 245 | 170 | 115 |
| 14 | 200 | 245 | 245 | 245 | 245 | 170 | 115 |
| 15 | — | — | — | — | — | — | — |
| 16 | 200 | 245 | 245 | 245 | 245 | 190 | 120 |
| 17 | 200 | 245 | 245 | 245 | 245 | 190 | 120 |

TABLE 3
Other Extrusion Conditions

| | | Extruder | | | | Final Moisture | Final MFR, |
|---|---|---|---|---|---|---|---|
| | Through-put | Speed | Tₘₑₗₜ | Pₘₑₗₜ | | Content | 190° C. |
| Sample | (lb/hr) | (rpm) | (° C.) | (psi) | Torque % | (ppm) | (g/10 min) |
| 1 | — | — | — | — | — | 484 | 25 |
| 2 | 12 | 500 | 161 | 30 | 61-63 | 308 | 77 |
| 3 | 12 | 500 | 157 | 20 | 48-52 | 204 | 110 |
| 4 | 12 | 500 | 147 | 20 | 42-46 | 264 | 170 |
| 5 | 12 | 500 | 153 | 10 | 38-41 | 1027 | 352 |
| 6 | — | — | — | — | — | 2217 | 5 |
| 7 | 10 | 500 | — | — | — | — | 43 |
| 8 | — | — | — | — | — | 490 | 4 |
| 9 | 15 | 500 | 176 | 80-90 | 82-86 | 377 | 15 |
| 10 | 15 | 500 | 176 | 70-80 | 79-84 | 437 | 18 |
| 11 | — | — | — | — | — | 2098 | 5 |
| 12 | 15 | 500 | 176 | 60 | 78-81 | 1451 | 31 |
| 13 | 12 | 500 | 120 | 20 | 36-42 | 682 | 126 |
| 14 | 12 | 500 | 120 | 20 | 27-30 | 730 | 553 |
| 15 | — | — | — | — | — | 2232 | 41 |
| 16 | 12 | 500 | 134 | 0 | 29-32 | 1808 | 622 |
| 17 | 12 | 500 | 131 | 0 | 29-32 | 1800 | 760 |

As indicated, a significant increase in final melt flow rate (MFR) was observed after moist melt processing under high shear conditions. The melt flow rate of the EnPol™ G4560J resin, for instance, was increased from 25 to about 170 MFR after melt processing. The melt flow rate of the Ecoflex® resin was increased from 5 to 31 when a moist resin having 2098 ppm moisture was melt processed under high shear conditions. A significant increase in final MFR (i.e., between about 620 to 760 g/10 min) was also observed when moist resin blends with PLA and PEG were melt processed.

### Example 2

Sample 12 of Example 1 was tested to determined the effect of drying on the final melt flow rate (MFR). The drying conditions and test results are set forth below in Table 4.

TABLE 4
Properties of Dried Resin

| | | | | Final | |
|---|---|---|---|---|---|
| | | | Final Moisture | MFR, | |
| | | Drying | Content | 190° C. | % MFR |
| Sample | Polymer | conditions | (ppm) | (g/10 min) | Reduction |
| 12 | Ecoflex | — | 1451 | 31 | — |
| | FBX7011 | 140° F., | 102 | 30 | 3.23 |
| | | 48 hours | | | |

As indicated, some reduction in melt flow rate was indicated after drying.

### Example 3

Several of the resins of Example 1 were tested to determine their molecular weight. The results are shown in below in Table 5.

TABLE 5
Molecular Weight

| | | | | Poly. |
|---|---|---|---|---|
| Sample No. | Mw_{z} | Mw_{w} | Mwₙ | Index |
| 1 | 201400 | 135100 | 84800 | 1.59 |
| 2 | 163800 | 114400 | 71200 | 1.61 |
| 3 | 155100 | 107100 | 64900 | 1.65 |
| 4 | 144000 | 100900 | 63000 | 1.60 |
| 5 | 145200 | 95400 | 57000 | 1.67 |

As indicated, modification of the resin resulted in a significant reduction in number average molecular weight (Mwₙ′), weight average molecular weight (Mw_{w}), and z-average molecular weight (Mw_{z}). For instance, the number average molecular weight of Sample No. 4 was reduced to 63,000 from 84,000 and the weight average molecular weight was reduced to 100,900 from 135,100.

### Example 4

Coform webs were formed from “NF 405” pulp and three (3) different types of PBS resins using conventional equipment, such as described above. Samples A and B were formed from the resin of Sample No. 4 (Example 1) and extruded as a monocomponent fiber. The resin was dried overnight at about 150° F. before wet processing. A control coform web was also formed that contained a polypropylene resin available under the designation “PF015” from Basell. The conditions for forming the coform webs are set forth below in Table 6. Further, various mechanical properties of the webs are set forth below in Table 7.

TABLE 6
Coform Web Processing Conditions

| | Sample | | | | | |
|---|---|---|---|---|---|---|
| | Control | | A | | B | |
| Extruder | 1 | 2 | 1 | 2 | 1 | 2 |
| Normalized Throughput | 1 | 1 | 1 | 1 | 1 | 1 |
| (lb/in/hour/die tip) | | | | | | |
| Polymer Type | PF015 | PF015 | PBS | PBS | PBS | PBS |
| Extruder Barrel | 500 | 500 | 360 | 360 | 360 | 360 |
| Temperature, ° F. | | | | | | |
| Auxiliary Equip. | 500 | 500 | 320 | 320 | 320 | 320 |
| Temp., ° F. | | | | | | |
| Adapter Temp, ° F. | 500 | 500 | 360 | 360 | 360 | 360 |
| Die Tip Melt Temp, ° F. | 487 | 500 | 375 | 375 | 375 | 375 |
| Die Tip Attenuation | 1.7 | 1.7 | 2.5 | 2.5 | 2.5 | 2.5 |
| Air Pressure (psi) | | | | | | |
| Die Tip Attenuation | 550 | 550 | 425 | 425 | 425 | 425 |
| Air Temperature, ° F. | | | | | | |

| | | | |
|---|---|---|---|
| Basis Wt. (gsm) | 63 | 63 | 65 |
| Pulp Content (wt. %) | 73 | 73 | 65 |
| Resin Content (wt. %) | 27 | 27 | 35 |

TABLE 7
Coform Web Properties

| | Peak Load, MD | | Peak Load, CD | % Strain, |
|---|---|---|---|---|
| Material | (gf) | % Strain, MD | (gf) | CD |
| Control | 575 ± 43 | 15 ± 2 | 194 ± 4 | 87 ± 9 |
| A | 124 ± 11 | 11 ± 1.4 | 68 ± 9.3 | 30 ± 2 |
| B | 250 ± 21 | 12 ± 2 | 117 ± 20 | 34 ± 5 |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method for forming a biodegradable polymer for use in fiber formation, the method comprising melt processing a first biodegradable polyester at a water content of from about 500 ppm to about 5000 ppm, based on the dry weight of the first polyester, wherein the first polyester undergoes a hydrolysis reaction that results in a second, hydrolytically degraded polyester having a melt flow rate that is greater than the melt flow rate of the first polyester, determined on a dry basis at a load of 2160 grams and temperature of 190° C. in accordance with ASTM Test Method D1238-E.

2. The method of claim 1, wherein the ratio of the melt flow rate of the second polyester to the melt flow rate of the first polyester is at least about 1.5.

3. The method of claim 1, wherein the ratio of the melt flow rate of the second polyester to the melt flow rate of the first polyester is at least about 10.

4. The method of claim 1, wherein the second polyester has a number average molecular weight of from about 10,000 to about 70,000 grams per mole and a weight average molecular weight of from about 20,000 to about 125,000 grams per mole.

5. The method of claim 1, wherein the second polyester has a number average molecular weight of from about 20,000 to about 60,000 grams per mole and a weight average molecular weight of from about 30,000 to about 110,000 grams per mole.

6. The method of claim 1, wherein the first and second polyesters both have a melting point of from about 80° C. to about 160° C.

7. The method of claim 1, wherein the first and second polyesters both have a glass transition temperature of about 0° C. or less.

8. The method of claim 1, wherein the melt flow rate of the second polyester is from about 10 to about 1000 grams per 10 minutes.

9. The method of claim 1, wherein the melt flow rate of the second polyester is from about 100 to about 800 grams per 10 minutes.

10. The method of claim 1, wherein the first polyester is an aliphatic polyester.

11. The method of claim 10, wherein the first polyester is polybutylene succinate or a copolymer thereof.

12. The method of claim 1, wherein the first polyester is an aromatic-aliphatic copolyester.

13. The method of claim 1, wherein the water content is from about 1000 to about 4500 ppm, based on the dry weight of the first polyester.

14. The method of claim 1, wherein the water content is from about 2000 to about 3500 ppm, based on the dry weight of the first polyester.

15. The method of claim 1, wherein melt processing occurs at a temperature of from about 100° C. to about 500° C. and an apparent shear rate of from about 100 seconds⁻¹ to about 10,000 seconds⁻¹.

16. The method of claim 1, wherein melt processing occurs at a temperature of from about 150° C. to about 350° C. and an apparent shear rate of from about 800 seconds⁻¹ to about 1200 seconds⁻¹.

17. The method of claim 1, wherein melt processing occurs within an extruder.

18. The method of claim 1, wherein the second polyester is extruded through a meltblowing die.

19. The method of claim 1, wherein the first polyester is melt processed in conjunction with a plasticizer.

20. A fiber comprising a biodegradable, hydrolytically degraded polyester, wherein the polyester has a melt flow rate of from about 10 to about 1000 grams per 10 minutes, determined on a dry basis at a load of 2160 grams and temperature of 190° C. in accordance with ASTM Test Method D1238-E.

21. The fiber of claim 20, wherein the melt flow rate of the polyester is from about 100 to about 800 grams per 10 minutes.

22. The fiber of claim 20, wherein the polyester has a number average molecular weight of from about 10,000 to about 70,000 grams per mole and a weight average molecular weight of from about 20,000 to about 125,000 grams per mole.

23. The fiber of claim 20, wherein the polyester has a number average molecular weight of from about 20,000 to about 60,000 grams per mole and a weight average molecular weight of from about 40,000 to about 80,000 grams per mole.

24. The fiber of claim 20, wherein the polyester has a melting point of from about 80° C. to about 160° C.

25. The fiber of claim 20, wherein the polyester has a glass transition temperature of about 0° C. or less.

26. The fiber of claim 20, wherein the polyester is an aliphatic polyester.

27. The fiber of claim 26, wherein the polyester is polybutylene succinate or a copolymer thereof.

28. The fiber of claim 20, wherein the polyester is an aromatic-aliphatic copolyester.

29. The fiber of claim 20, wherein the fiber is a multicomponent fiber, wherein at least one component of the fiber contains the biodegradable, hydrolytically degraded polyester.

30. The fiber of claim 20, wherein the fiber is a multiconstituent fiber, wherein at least one constituent of the fiber contains the biodegradable, hydrolytically degraded polyester.

31. A nonwoven web comprising the fiber of claim 20.

32. The nonwoven web of claim 31, wherein the web is a meltblown web.

33. The nonwoven web of claim 31, wherein the web is a composite that further comprises an absorbent material.

34. The nonwoven web of claim 33, wherein the composite is a coform web.

35. A nonwoven laminate comprising a spunbond layer and a meltblown layer, wherein the meltblown layer includes the nonwoven web of claim 31.

36. An absorbent article comprising an absorbent core positioned between a liquid-permeable layer and a generally liquid-impermeable layer, the absorbent article comprising the nonwoven web of claim 31.

37. The absorbent article of claim 36, further comprising a wrapsheet layer, ventilation layer, surge management layer, or a combination thereof, wherein one or more of the layers comprise the nonwoven web.

38. The absorbent article of claim 36, further comprising one or more containment flaps, which comprise the nonwoven web.

39. A wipe comprising the nonwoven web of claim 31.

40. The wipe of claim 39, further comprising a wet wipe solution.
